(19) United States
(12) Patent Application Publication
(10) Pub. No.: US 2005/0053901 A1
(43) Pub. Date: Mar. 10, 2005

(54) Color coded educational learning aid and learning method

(76) Inventor: Joycelyn Annette Johnson, Chicago, IL (US)

Correspondence Address: KATTEN MUCHIN ZAVIS ROSENMAN, 525 WEST MONROE STREET, CHICAGO, IL, 60661-3693, US

(21) Appl. No.: 10/654,712

(22) Filed: Sep. 4, 2003

(51) Int. Cl. G09B 17/00

(52) U.S. Cl. 434/178

(57) ABSTRACT

An educational learning aid teaches subjects that combine creative thought processes, inspired, for example, by music, art, color and other visual and audible stimulations, with analytic subjects, such as writing composition, math, reading, science and the like. In one embodiment, colors are used to stimulate the development of a writing composition. The writing composition may be divided into individual color coded story elements such as plot, resolution, setting, and characters of a story. In an exemplary embodiment, a color coded educational device teaches writing composition by guiding the writer to develop each story element individually. The color coded educational device associates each color coded story element with a corresponding story element module. The writer writes each story element on a corresponding color coded story element module. The story element modules may then be collected and organized in a story element organizer for future access such as for editing. The writer may begin writing and revising the composition from each of the story element modules stored in the story element organizer.

### BACKGROUND OF THE INVENTION

1. Field of the Invention

The present invention relates to educational learning aids and methods. More particularly, to educational learning aids and methods for facilitating learning by forming associations between educational subjects and creative processes.

2. Description of the Prior Art

Educational learning aids are generally known in the art. Examples of learning aids are disclosed in U.S. Pat. Nos. 6,053,741 and 6,129,550. In particular U.S. Pat. No. 6,053,741 discloses a flash card holder for a flash card. The flash card holder includes a viewing window which allows the answer to be seen when appropriately positioned relative to the viewing window to facilitate the teaching of mathematical skills.

U.S. Pat. No. 6,129,550 discloses an educational tool for educating children, such as special education children, how to set a table. The educational tool includes a placemat with color coded images of the various items in a place setting, including various eating utensils, dishes, cups, glasses and a napkin. Each of the various items is color coded and is color matched to the various items represented by the images.

Although the educational tools mentioned above may be effective in facilitating the teaching of skills related to setting a table and mathematical skills, neither of these educational tools facilitate the teaching of writing skills. Moreover, neither of the educational tools discussed above stimulate the creative thought processes of the human brain by stimulating right side of the human brain, with music, art, color or other visible or audible stimulations while facilitating an analytical thought process, normally associated with the right side of the human brain. Thus, there is a need for an educational tool for facilitating the teaching of writing skills.

### SUMMARY

An educational aid that facilitates teaching of subjects in a way that stimulates creative thought processes, stimulated, for example, by music, art, color and other visual and audible stimulations, for analytic skills, such as writing composition, math, reading, science and the like. In one embodiment, colors are used to stimulate the development of writing composition. The writing composition may be divided into individual color coded story elements such as plot, setting, and characters of a story. In an exemplary embodiment, a color coded educational device teaches writing composition by guiding the writer to develop each story element individually. The color coded educational device associates each color coded story element with a corresponding story element module. The writer writes each story element on a corresponding color coded story element module. The story element modules may then be collected and organized in a story element organizer for future access such as for editing. The writer may begin writing and revising the composition from each of the story element modules stored in the story element organizer.

### BRIEF DESCRIPTION OF THE DRAWING

These and other features will become better understood with regard to the following description, appended claims, and accompanying drawings where:

FIG. 1 illustrates an exemplary embodiment of a color coded story element organizer;

FIG. 2 illustrates an exemplary embodiment of a plurality of colored story element inserts;

FIG. 3 is a block diagram of a method for creating a structured content writing.

### DETAILED DESCRIPTION OF THE INVENTION

Specialization Areas of the Brain

The present invention relates to an educational aid that facilitates teaching of subjects in a way that stimulates creative thought processes, stimulated by creative thought processes, stimulated by color, for example for use in developing analytical skills, such as writing composition. In particular, composition writing is divided into individual color coded story elements, such as plot, setting, and characters of a story. Each story element is drafted on a color coded story module. As such, the educational aid in accordance with the present invention is able to optimize different parts of the brain.

Different parts of the brain are known to be used for different functional types of thinking. In particular, the left side of the brain is known to be associated with verbal, logical, and analytical thinking. The left side of the brain is known as the superior temporal region and is known to perform structured functions such as reading, writing, and arithmetic. It excels in naming and categorizing things, symbolic abstraction, speech, and arithmetic. This part of the brain functions in a systematic, sequential and exact manner. Traditionally, educational training of analytic subjects such as science, reading, writing, and arithmetic, was taught primarily in a logical and analytic manner.

The right brain functions in a non-verbal manner and specializes in visual, spatial, perceptual, and intuitive information. The right brain is commonly associated with creativity and expressiveness. This portion of the brain processes information relatively quickly in a nonlinear and non-sequential manner. The right brain processes an entire image and quickly seeks to determine the spatial relationships of all the parts as they relate to the whole. It does not process information in conformance with patterns in prescribed rules. Instead, the right brain appears to be well suited with creativity, complexity, ambiguity and paradox.

As previously stated, the left brain is associated with analytic functions whereas the right brain is commonly associated with creativity and expressiveness. As creative skills are developed, people who are right dominant often develop the ability to suspend the functions of the left brain and release the creative power of the right brain. Conversely, as analytic skills are developed, people who are left dominant have a tendency to develop the ability to suspend their creative skills and concentrate on logical and analytic functions. However, effective learning is not fully achieved by thinking that the left and right brain specializations are totally separate. The ultimate goal of learning effectively and efficiently at one's maximum ability is to approach learning, work and life using a “whole brain” approach.

Thinking with both the analytic and creative processes together, even simultaneously, is possible because the two portions of the brain are connected and have areas of overlap. Accordingly, a learning aid is effective at teaching a subject when it is simple, and it further facilitates the development of connections between the two sides of the brain in order to permit and further develop thinking with both the analytic and creative process.

The use of stimulating colors, images, music, and sounds when learning analytic subjects readily engage both the right hemisphere along with the left hemisphere so that learning can be more meaningful to those who are either right-dominate or left-dominate. Students learn associations between visual forms of words and their semantic referents more easily through the use of these stimulants. For example, the visual forms and colors associated with words are stored and associated as visual images along with the analytic subject structure. Accordingly, educational learning aids may be designed to teach subjects that associate creative thought processes such as colors, music and other audio and visual stimulations with analytic subjects such as writing composition, reading, math, science and the like.

Story Elements of a Writing Composition

The embodiments described are presented for purposes of illustration and description only, and other embodiments will be apparent to and could be implemented by practitioners skilled in this art. An educational learning aid and method facilitates the learning of analytic subjects such as writing composition through color associations.

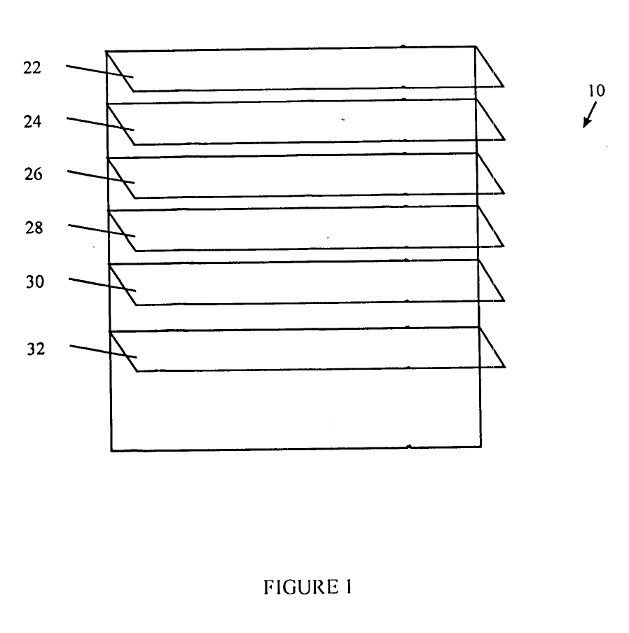

As shown in FIG. 1, in an exemplary embodiment, the educational aid is a writing composition organizer 10 configured with different colors to represent different story elements. The story element organizer has a plurality of story element modules corresponding to story elements in a writing composition. In one embodiment, the story element organizer teaches “story grammar” (story elements in fiction or fact) to a writer of any level of proficiency. The story element organizer introduces the student to the basic elements of writing composition for creative, factual, or analytic subject matter. After drafting the story elements, the student has identified the character(s), the problem, the plot, and the setting for a particular story.

Students, such as children or beginning writers learning to write a composition, often are able to write fiction by generating many ideas through a creative thought process. However, these writers often have undeveloped organizational skills and consequently do not first develop the story elements. Further, children often are not taught how to write about subject areas other than fiction. Subject areas, particularly highly structured areas such as science, social studies and geography require a more structured approach to writing. Through the use of the educational learning aid and learning method described, a writer will know how to plan for writing, prepare the story elements, write a fictional or non-fictional story, and present the story in a structured, cohesive, logical manner.

The educational learning aid and method may be tailored specifically to the student's age group or proficiency level and to the subject area. In one embodiment, the writing organizer may be specifically designed for first and second grade students. First and second grade students are not expected to elaborate beyond the basic requirements of identifying the story elements. However, students in higher grades are capable of producing more detail for each story element. Since more is required of students in grades 3-5, and 6-8 and higher, the 5 W's (who, what, where, when and why) may be included with the story element modules 10. The students may then be encouraged to elaborate creatively to produce many concrete examples and details such as the 5W's. Accordingly, each story element may be further developed with the 5W's, or each story element may have additional subsections for each of the 5W's.

Story Element Organizer

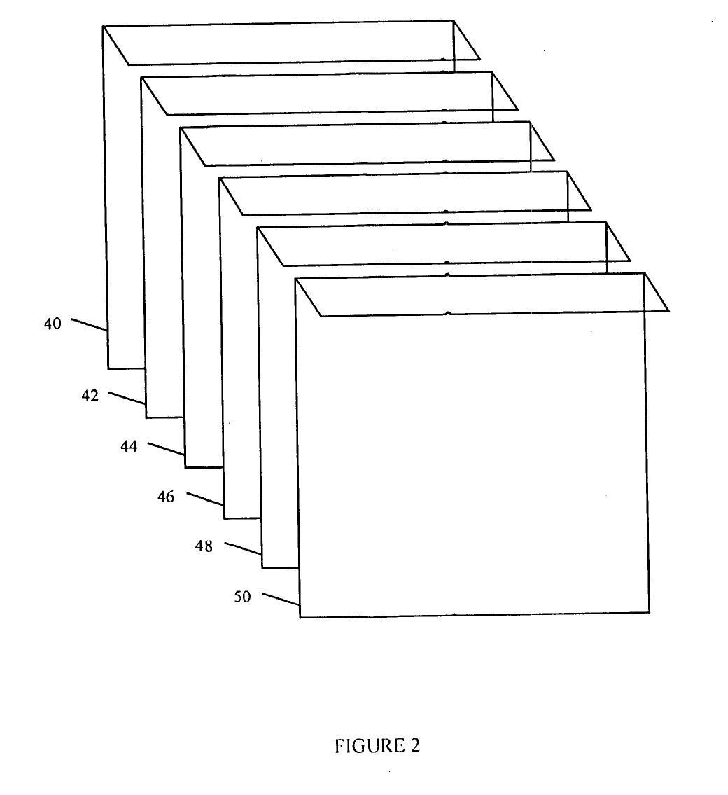

A color coded story element organizer 10 is shown in FIG. 1 according to one exemplary embodiment of the invention. Although FIG. 1 illustrates a cascading colored envelope organizer as the story element organizer 10, any device capable of organizing story elements may be used. FIG. 2 illustrates a plurality of colored story element modules as inserts 40-50 for insertion into the cascading colored envelope organizer 10. The story element organizer 10 may have several colored envelopes 22-32 for accepting a corresponding colored story element insert 40-50.

In one embodiment, the story element modules 40-50 are colored sheets of paper. In another embodiment, the student may write each story element on white paper with colored pencils or pens corresponding to different story elements. In another embodiment, the story element modules may be a color coded window, icon, menu or the like on a computer screen. For example, a user may select a window, icon, or menu on the computer screen corresponding to a story element for entering text. Audio stimulations, such as music, sounds and voices, may also be associated with the story elements to further facilitate creative associations and the creative process generally.

Each cascading envelope 22-32 accepts a story element insert 40-50 and each story element insert 40-50 is associated with a story element. In one embodiment, the story elements may be used for drafting a creative writing composition. For example, the story elements may be one or more of the following: plot, setting, characters, or resolution. Fewer or more elements may be used to represent a story element. For example, the plot may be further subdivided into sub-plots and the setting may be further subdivided into related or unrelated sub-settings. Further, story elements may be defined for other criteria as appropriate such as motive, conflict, character interactions, and multiple related or unrelated stories. In another embodiment, the story elements may be used for drafting a factual writing composition. According to this embodiment, the story elements may be organized into sub-categories sub-modules. or sub-inserts related to who, what, where, when, how, and why.

The story element organizer 10 may be made of any appropriate material such as paper, plastic, metal, wood, cardboard, rubber and the like. In the embodiment shown in FIG. 1, each envelope 22-32 in the cascading story element organizer 10 is formed from a folded sheet of paper with a fold at a top end of the envelope to form an envelope flap. In another embodiment, the envelopes are not cascading vertically, but stacked apart, horizontally or diagonally and adjacent to each other. In yet another embodiment, the story element organizer 10 is in the form of a box having slots for accepting inserts 40-50. Alternatively, the story element organizer 10 is a spiral hangar having hooks for hanging story element modules 40-50. In another embodiment, the story element organizer 10 is a wedge, or a type of polygon such as a pyramid or triangle with a series of openings for accepting inserts 40-50.

In one embodiment, each story element may be represented by different colored papers, having different shapes and sizes. The different colors, shapes, and sizes provide stimulating visualizations to the writer for inspiring creativity. For example, the writing organizer may simply be a color-coded wheel where each color is used as a guide for inspiring the writer to develop the story elements. Each section of the color wheel may be associated with a story element as shown in FIG. 5. The color wheel may be used to help the students develop each story element in a structured fashion and to distinguish the different parts of the story. As previously described, the story element modules 40-50 and the story element organizer 10 may also introduce the 5 W's to each story element.

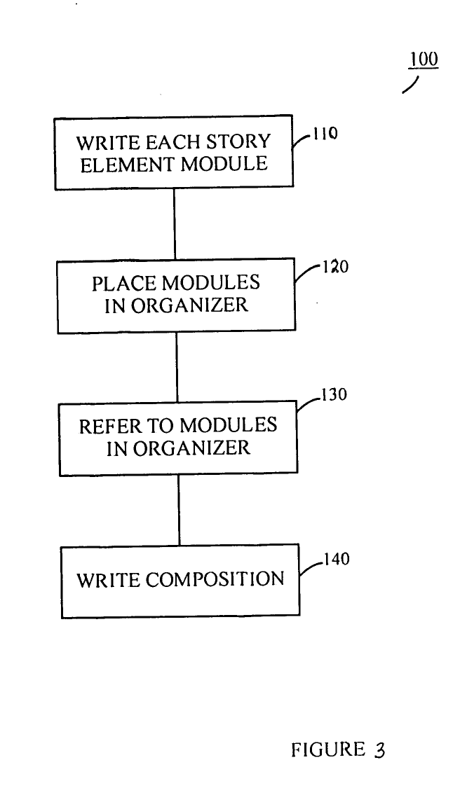

As shown in FIG. 3, the method 100 for creating a structured writing begins at step 110 by writing each of the story elements onto a story element module 40-50. As described above, each story element module is associated with a different color. Research has shown that colors, sizes, shapes, etc. connect the right hemisphere of the human brain to the left hemisphere. It is this connection of the two hemispheres which allows for more efficient use of the whole brain.

Once the writer has completed writing each story element, the writer may, at step 120, organize the story by placing each story element module 40-50 into the story element organizer 10. As the writer composes the story, the writer may easily refer to any of the story elements at step 130 by selecting and removing the appropriate story element module 40-50 from the story element organizer 10. The writer may quickly identify the proper story element module 40-50 by the color and location of the story element module 40-50 in the organizer 10. As a result, the student writer has their own graphic device that they can use as a guide or road map to writing a composition, story, or any writing content. As previously stated, the colors, sizes and shapes of the modules and other visual, and audio stimulations provide inspiration for developing each story element. These inspirations trigger creative processes and analytic associations within the student's mind.

Once the writer has drafted the story elements, the writer may begin the process of writing the composition at step 140. At this point, the writer may review the story elements in order to compile each portion of the writing composition. The writing organizer facilitates the creative development and reduction of the ideas to a writing through the use of stimulating colors associated with each story element. The writer associates each color with new creative ideas related to the story element as a result of recognizing the story element color. Accordingly, when the writer wants to refer a particular story element to write a particular portion of the composition, such as the plot, the writer's creative thought processes associated with the plot are triggered by an association with the color corresponding to the plot. Through this creative process, the writing organizer may inspire and facilitate more creative thinking resulting in more ideas thus inspiring and motivating the writer to further develop and refine the story element modules.

Finally, when the writer is editing the composition, the writer may refer to the story element organizer as an aid to further stimulate creativity. During editing, the writer may identify and revise a particular sentence or word in order to further convey an idea. As the writer contemplates editing the composition with respect to a particular story element, the color associated with the story element creates new thoughts. Since the color associated with the story element triggers new first impressions, new ideas are developed by the creative side of the brain. Additionally, the creative side of the brain can have an emotional impact on the writer. As a result, the writer can then express the emotion in the story elements and composition through the creative writing and editing process.

This process of guiding the writer to focus on writing the individual story elements acquaints the writer with the concept of story structure. Once the writer learns how to write each story element, the writer will learn to become even a more proficient writer with experience.

Through the practice of structured writing, the writer also learns how narrative stories unfold. Since the writer has knowledge of the story structure and how a story is composed, the writer can identify the story elements facilitating the development of improved reading skills and reading comprehension. Knowledge of the meaning and scope of the story elements will aid the writer into becoming a better reader because the reader will be able to determine how to identify the story elements in a composition.

As the writer gains more experience, the writer may use a journal as an instructional or educational device to record notes and to further strengthen those composition skills learned from each writing experience. Accordingly, the journal may be used to build upon these fundamental foundations for further reinforcing the learned skills and for learning new skills.

Obviously, many modifications and variations of the present invention are possible in light of the above teachings. Thus, it is to be understood that, within the scope of the appended claims, the invention may be practiced otherwise than as specifically described above.

What is claimed and desired to be covered by a Letters Patent is as follows:

1. A color coded educational device comprising:
a plurality of story elements, each associated with a different respective color;
a story element module associated with each story element wherein each story element module is associated with the different respective color associated with each story element;
a story element organizer for organizing the plurality of story element modules by their respective color; and
a content writing formed from the plurality of story element modules.

2. The device of claim 1 wherein the story elements are selected from the group consisting of plot, setting, characters, resolution, who, what, when, where, and why.

3. The device of claim 1 wherein the story element modules are selected from the group consisting of one or more colored pencils, colored flash cards, computer icons, graphics, windows, text pages, and menus.

4. The device of claim 1 wherein the story element modules are selected from the group of characteristics consisting of different colors, different sizes, and different shapes, wherein the story element module characteristics relate to the relative importance of the writing content.

5. The device of claim 1 wherein the story elements associated with each story element module comprises:
a story plot associated with a story plot insert having a first color;
a story resolution associated with a story resolution insert having a second color;
a story setting associated with a story setting insert having a third color;
a story character associated with a story character insert having a fourth color;
wherein the story element organizer is a cascading envelope organizer comprising:
a first colored slot for accepting the story plot insert;
a second colored slot for accepting the story resolution insert;
a third colored slot for accepting the story setting insert; and
a fourth colored slot for accepting the story character insert,
wherein the content writing is formed from the story plot, resolution, setting, and character.

6. A method for creating a content writing comprising:
writing a plurality of story elements on corresponding story element modules, wherein each story element module is associated with a different respective color;
organizing each story element module with a story element organizer; and
creating the content writing from each of the story element modules.

7. The method of claim 6 wherein the plurality of story elements are selected from the group of story elements consisting of plot, setting, characters, resolution, who, what, when, where, and why.

8. The method of claim 7 wherein the story element modules are selected from the group consisting of colored paper, white paper, colored pencils, colored flash cards, computer icons, cascading colored envelopes and colored story element inserts.

9. The method of claim 8 wherein the plurality of story element modules are chosen from the group consisting of computer icons, graphics, windows, menus, computer screens, and text pages on a computer screen, wherein each story element module is associated with the different respective color, and the story element organizer is a computer graphic for organizing the story element modules.

10. The method of claim 8 wherein the story element organizer is a cascading envelope organizer, the method comprising:
writing a story plot on a story plot insert having a first color;
writing a story resolution on a story resolution insert having a second color;
writing a story setting on a story setting insert having a third color;
writing a story character on a story character insert having a fourth color;
inserting the story plot insert into a first slot of the cascading envelope organizer;
inserting the story resolution insert into a second slot of the cascading envelope organizer;
inserting the story setting insert into a third slot of the cascading envelope organizer;
inserting the story character insert into a fourth slot of the cascading envelope organizer; and
drafting the content writing from the story plot, resolution, setting, and character.
